(19) United States
(12) Patent Application Publication
(10) Pub. No.: US 2014/0223668 A1
(43) Pub. Date: Aug. 14, 2014

(54) METHOD FOR INCREASED FRAGRANCE RELEASE DURING IRONING

(71) Applicants: Yelloji-Rao K. Mirajkar, Piscataway, NJ (US); Ana Acosta, Miguel Hidalgo (MX); Jose Javier Tovar Pescador, Miguel Hidalgo (MX); Amjad Farooq, Hillsborough, NJ (US); Amit Sachdev, Mexico (MX); Oscar Bautista Cid, Miguel Hidalgo (MX)

(72) Inventors: Yelloji-Rao K. Mirajkar, Piscataway, NJ (US); Ana Acosta, Miguel Hidalgo (MX); Jose Javier Tovar Pescador, Miguel Hidalgo (MX); Amjad Farooq, Hillsborough, NJ (US); Amit Sachdev, Mexico (MX); Oscar Bautista Cid, Miguel Hidalgo (MX)

(73) Assignee: COLGATE-PALMOLIVE COMPANY, Piscataway, NJ (US)

(21) Appl. No.: 14/241,962

(22) PCT Filed: Aug. 31, 2012
(86) PCT No.: PCT/US12/53296

§ 371 Date: Feb. 28, 2014

(30) Foreign Application Priority Data
Sep. 1, 2011 (US) PCT/US2011/050117

(51) Int. Cl. C11D 3/50

(52) U.S. Cl. CPC C11D 3/50
USPC 8/137

(57) ABSTRACT

A method for increasing blooming of fragrance during ironing a fabric comprising laundering the fabric with a composition comprising a linear polyether having a weight average molecular weight less than 5000 that is terminated with —N—(—CH₂—CH(OH)—CH₂—Cl)₂, and fragrance and ironing the fabric.

### CROSS REFERENCE TO RELATED APPLICATIONS

This application is a continuation-in-part of Application No. PCT/US2011/050117, filed 1 Sep. 2011, which is incorporated herein by reference.

### FIELD OF THE INVENTION

The present invention relates to a method for increased fragrance release during ironing.

### BACKGROUND OF THE INVENTION

After laundering of fabric, fabric is ironed. Typically, the ironing process is made more pleasant by the fragrance that is retained on the fabric after laundering. It would be desirable to increase the fragrance release during ironing.

WO01/27232A1 discloses a fabric care composition comprising a polymeric material that is capable of self cross-linking and/or of reacting with cellulose together with one or more textile compatible carriers, wherein the polymeric material comprises one or more poly(oxyalkylene) groups having an end group which comprises one or more amino groups or derivatives of said amino groups. The compositions may be used to treat fabric as part of a laundering process and improve the surface color definition of the fabric following multiple washings.

US2003/0162689A1 (WO03/062361A1) discloses a liquid fabric conditioner for fabric care and to the use of the conditioner in a washing or laundry drying process, to a conditioning substrate containing a liquid fabric conditioner, and to a conditioning process using the conditioning substrate in a laundry drying process. The liquid fabric conditioner and conditioning substrate are used to reduce fluff formation and pilling.

US2007/0021315A1 discloses that hard water is softened by a composition comprising a fatty acid and/or an alkali salt thereof, a dispersing agent and a precipitation softener thereby simultaneously forming and dispersing an insoluble calcium salt of the fatty acid.

GB2378960A discloses a fabric care composition comprises a fluorocarbon stain-blocking agent and a cationic cross-linking polymeric material which is capable of self cross-linking and/or of reacting with cellulose together with one or more textile compatible carriers, wherein the cationic cross-linking polymeric material comprises one or more poly(oxyalkylene) groups having an end group which comprises one or more amino groups or derivatives of said amino groups. Use of the composition improves the surface color definition and stain repellency of a fabric after multiple washings and imparts pill and/or fuzz resistance.

EP372848A2 discloses an aqueous emulsion of a perfluoropolyether having a molecular weight in the range 3000 to 8000 is made by agitating the perfloropolyether with a non-ionic non-fluorine-containing surfactant having an HLB value in the range 11.5 to 17. The emulsions may be used in fabric conditioners.

### BRIEF SUMMARY OF THE INVENTION

A method for increasing blooming of fragrance during ironing a fabric comprising laundering the fabric with a composition comprising a linear polyether having a weight average molecular weight less than 5000 that is terminated with —N—(—CH₂—CH(OH)—CH₂—Cl)₂, and fragrance and ironing the fabric.

Also a use of a linear polyether having a weight average molecular weight less than 5000 that is terminated with —N—(—CH₂—CH₂(OH)—CH₂—Cl)₂ and fragrance to treat a fabric to increase blooming of fragrance during ironing of the fabric.

In certain embodiments, the molecular weight is less than 2000.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE INVENTION

The following description of the preferred embodiment(s) is merely exemplary in nature and is in no way intended to limit the invention, its application, or uses.

Provided is a method for increasing blooming of fragrance during ironing a fabric comprising laundering the fabric with a composition comprising a linear polyether having a weight average molecular weight less than 5000 that is terminated with —N—(—CH₂—CH(OH)—CH₂—Cl)₂, and fragrance and ironing the fabric.

The laundering can start with machine washing or hand washing. Washing typically includes using a detergent in a wash cycle. Washing is usually followed by a rinse cycle. After washing and rinsing, fabrics can be dried by hanging on a line or in a dryer. The fabric can be ironed after drying.

Also provided is a use of a linear polyether having a weight average molecular weight less than 5000 that is terminated with —N—(—CH₂—CH(OH)—CH₂—Cl)₂ to treat a fabric to increase blooming of fragrance during ironing of the fabric.

The method or use can be used on any type of fabric. In certain embodiments, the fabric is in need of an increased fragrance release. Typical fabrics include any fabric used to make clothing, such as cotton, polyester, elastane, or denim. In certain embodiments, the fabric is denim.

The composition used in the method can be used during any step of the laundering method. In certain embodiments, the composition is added during the rinse cycle. It has been found that multiple launderings can increase the fragrance release. The fabric can be laundered with the composition for at least 3 times or at least 5 times.

The composition contains a linear polyether having a weight average molecular weight less than 5000 that is terminated with —N—(—CH₂—CH(OH)—CH₂—Cl)₂. In other embodiments, the molecular weight is less than 4000, less than 3000, or less than 2000. In certain embodiments, the polymer has a molecular weight less than 2000. This polymer having a molecular weight less than 2000 is available from Devan Chemical under the Passerelle™ trademark as DP5270 or DFD. DP5270 is sold as an aqueous composition that contains 20% polymer with a total solids of 23-24%, with the other solids being surfactants. The DFD product contains 82% of the DP5270 product and further contains ethoxylated fatty-quaternary softeners. The amount of the polymer in the composition is 0.05 to 0.4% by weight of the composition. In one embodiment, the amount of DP5270, as-is, is 0.35 to 2% by weight of the composition.

In one embodiment, the polyether is included in a fabric conditioner. A fabric conditioner composition contains a fabric softener material. In certain embodiments, the softener is a cationic softener selected from among esterquats, imidazolinium quats, difatty diamide ammonium methyl sulfate, ditallow dimethyl ammonium chloride, and mixtures thereof.

In certain embodiments, the cationic fabric softener is an esterquat. The esterquats of the following formula:

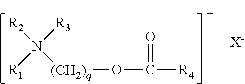

wherein R₄ is an aliphatic hydrocarbon group having from 8 to 22 carbon atoms, R₂ and R₃ represent (CH₂)ₛ—R₅, where R₅ is an alkoxy carbonyl group containing from 8 to 22 carbon atoms, benzyl, phenyl, C₁-C₄ alkyl substituted phenyl, OH or H; R₁ is (CH₂)ₜ—R₆, where R₆ is benzyl, phenyl, C₁-C₄ alkyl substituted phenyl, OH or H; q, s, and t, each independently, are an integer from 1 to 3; and X′ is a softener compatible anion.

The esterquat is produced by reacting about 1.65 (1.5 to 1.75) moles of fatty acid methyl ester with one mole of alkanol amine followed by quaternization with dimethyl sulfate (further details on this preparation method are disclosed in U.S. Pat. No. 3,915,867). Using this ratio controls the amount of each of monoesterquat, diesterquat, and triesterquat in the composition. In certain embodiments, the alkanol amine comprises triethanolamine. In certain embodiments, it is desirable to increase the amount of diesterquat and minimize the amount of triesterquat to increase the softening capabilities of the composition. By selecting a ratio of about 1.65, the triesterquat can be minimized while increasing the monoesterquat.

Monoesterquat is more soluble in water than triesterquat. Depending on the AI, more or less monoesterquat is desired. At higher AI levels (usually at least 7%), more monoesterquat as compared to triesterquat is desired so that the esterquat is more soluble in the water so that the esterquat can be delivered to fabric during use. At lower AI levels (usually up to 3%), less monoesterquat is desired because during use, it is desired for the esterquat to leave solution and deposit on fabric to effect fabric softening. Depending on the AI, the amount of monoesterquat and triesterquat are adjusted to balance solubility and delivery of the esterquat.

In certain embodiments, the reaction products are 50-65 weight % diesterquat 20-40 weight % monoester, and 25 weight % or less triester, which are shown below:

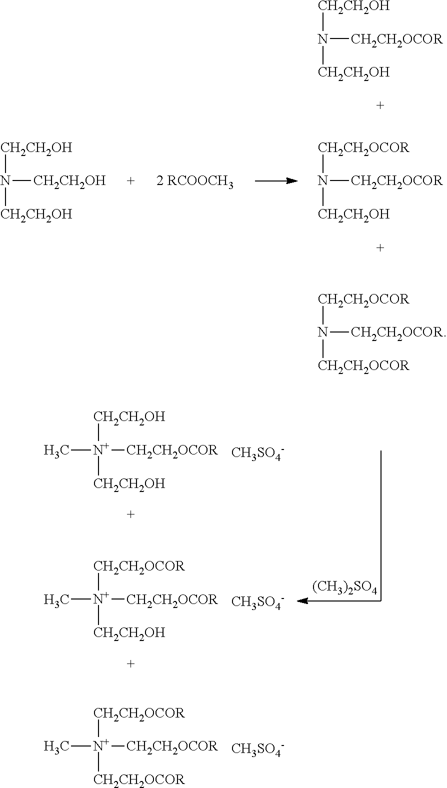

In other embodiments, the amount of diesterquat is 52-60, 53-58, or 53-55 weight %. In other embodiments, the amount of monoesterquat is 30-40 or 35-40 weight %. In other embodiments, the amount of triesterquat is 1-12 or 8-11 weight %.

The percentages, by weight, of mono, di, and tri esterquats, as described above are determined by the quantitative analytical method described in the publication “Characterisation of quaternized triethanolamine esters (esterquats) by HPLC, HRCGC and NMR” A. J. Wilkes, C. Jacobs, G. Walraven and J. M. Talbot—Colgate Palmolive R&D Inc.—4^{th} world Surfactants Congress, Barcelone, 3-7 VI 1996, page 382. The percentages, by weight, of the mono, di and tri esterquats measured on dried samples are normalized on the basis of 100%. The normalization is required due to the presence of 10% to 15%, by weight, of non-quaternized species, such as ester amines and tree fatty acids. Accordingly, the normalized weight percentages refer to the pure esterquat component of the raw material. In other words, for the weight % of each of monoesterquat, diesterquat, and triesterquat, the weight % is based on the total amount of monoesterquat, diesterquat, and triesterquat in the composition.

In certain embodiments, the percentage of saturated fatty acids based on the total weight of fatty acids is 45 to 75%. Esterquat compositions using this percentage of saturated fatty acids do not suffer from the processing drawbacks of 100% saturated materials. When used in fabric softening, the compositions provide good consumer perceived fabric softness while retaining good fragrance delivery. In other embodiments, the amount is at least 50, 55, 60, 65 or 70 up to 75%. In other embodiments, the amount is no more than 70, 65, 60, 55, or 50 down to 45%. In other embodiments, the amount is 50 to 70%, 55 to 65%, or 57.5 to 67.5%. In one embodiment, the percentage of the fatty acid chains that are saturated is about 62.5% by weight of the fatty acid. In this embodiment, this can be obtained from a 50:50 ratio of hard:soft fatty acid.

By hard, it is meant that the fatty acid is close to full hydrogenation. In certain embodiments, a fully hydrogenated fatty acid has an iodine value of 10 or less. By soft, it is meant that the fatty acid is no more than partially hydrogenated. In certain embodiments, a no more than partially hydrogenated fatty acid has an iodine value of at least 40. In certain embodiments, a partially hydrogenated fatty acid has an iodine value of 40 to 55. The iodine value can be measured by ASTM D5554-95 (2006). In certain embodiments, a ratio of hard fatty acid to soft fatty acid is 70:30 to 40:60. In other embodiments, the ratio is 60:40 to 40:60 or 55:45 to 45:55. In one embodiment, the ratio is about 50:50. Because in these specific embodiments, each of the hard fatty acid and soft fatty acid cover ranges for different levels of saturation (hydrogenation), the actual percentage of fatty acids that are fully saturated can vary. In certain embodiments, soft tallow contains approximately 47% saturated chains by weight.

The percentage of saturated fatty acids can be achieved by using a mixture of fatty acids to make the esterquat, or the percentage can be achieved by blending esterquats with different amounts of saturated fatty acids.

The fatty acids can be any fatty acid that is used for manufacturing esterquats for fabric softening. Examples of fatty acids include, but are not limited, to, coconut oil, palm oil, tallow, rape oil, fish oil, or chemically synthesized fatty acids. In certain embodiments, the fatty acid is tallow.

While the esterquat can be provided in solid form, it is usually present in a solvent in liquid form. In solid form, the esterquat can be delivered from a dryer sheet in the laundry. In certain embodiments, the solvent comprises water.

AI refers to the active weight of the combined amounts for monoesterquat, diesterquat, and triesterquat. Delivered AI refers to the mass (in grams) of esterquat used in a laundry load. A load is 3.5 kilograms of fabric in weight. As the size of a load changes, for example using a smaller or larger size load in a washing machine, the delivered AI adjusts proportionally. In certain embodiments, the delivered AI is 2.8 to 8 grams per load. In other embodiments, the delivered AI is 2.8 to 7, 2.8 to 6, 2.8 to 5, 3 to 8, 3 to 7, 3 to 6, 3 to 5, 4 to 8, 4 to 7, 4 to 6, or 4 to 5 grams per load.

The composition contains a fragrance. The amount of fragrance can be any desired amount depending on the preference of the user. In certain embodiments, the total amount of fragrance oil is 0.3 to 3 weight % of the composition. The fragrance can be in free form, encapsulated, or both.

Fragrance, or perfume, refers to odoriferous materials that are able to provide a desirable fragrance to fabrics, and encompasses conventional materials commonly used in detergent compositions to provide a pleasing fragrance and/or to counteract a malodor. The fragrances are generally in the liquid state at ambient temperature, although solid fragrances can also be used. Fragrance materials include, but are not limited to, such materials as aldehydes, ketones, esters and the like that are conventionally employed to impart a pleasing fragrance to laundry compositions. Naturally occurring plant and animal oils are also commonly used as components of fragrances.

The composition can contain any material that can be added to fabric softeners. Examples of materials include, but are not limited to, surfactants, thickening polymers, colorants, clays, buffers, silicones, fatty alcohols, and fatty esters.

The fabric conditioners may additionally contain a thickener. In one embodiment, the thickening polymer is the FLOSOFT™ DP200 polymer from SNF Floerger that is described in U.S. Pat. No. 6,864,223 to Smith et al., which is sold as FLOSOFT™ DP200, which as a water soluble cross-linked cationic polymer derived from the polymerization of from 5 to 100 mole percent of cationic vinyl addition monomer, from 0 to 95 mole percent of acrylamide, and from 70 to 300 ppm of a difunctional vinyl addition monomer cross-linking agent. A suitable thickener is a water-soluble cross-linked cationic vinyl polymer which is cross-linked using a cross-linking agent of a difunctional vinyl addition monomer at a level of from 70 to 300 ppm, preferably from 75 to 200 ppm, and most preferably of from 80 to 150 ppm. These polymers are further described in U.S. Pat. No. 4,806,345, and other polymers that may be utilized are disclosed in WO 90/12862. Generally, such polymers are prepared as water-in-oil emulsions, wherein the cross-linked polymers are dispersed in mineral oil, which may contain surfactants. During finished product making, in contact with the water phase, the emulsion inverts, allowing the water soluble polymer to swell. The most preferred thickener is a cross-linked copolymer of a quaternary ammonium acrylate or methacrylate in combination with an acrylamide comonomer. The thickener in accordance provides fabric softening compositions showing long term stability upon storage and allows the presence of relatively high levels of electrolytes without affecting the composition stability. Besides, the fabric softening compositions remain stable when shear is applied thereto. In certain embodiments, the amount of this thickening polymer is at least 0.001 weight %. in other embodiments, the amount is 0.001 to 0.35 weight %.

The fabric conditioner may further include a chelating compound. Suitable chelating compounds are capable of chelating metal ions and are present at a level of at least 0.001%, by weight, of the fabric softening composition, preferably from 0.001% to 0.5%, and more preferably 0.005% to 0.25%, by weight. The chelating compounds which are acidic in nature may be present either in the acidic form or as a complex/salt with a suitable counter cation such as an alkali or alkaline earth metal ion, ammonium or substituted ammonium ion or any mixtures thereof. The chelating compounds are selected from among amino carboxylic acid compounds and organo aminophosphonic acid compounds, and mixtures of same. Suitable amino carboxylic acid compounds include: ethylenediamine tetraacetic acid (EDTA); N-hydroxyethylenediamine triacetic acid; nitrilotriacetic acid (NTA); and diethylenetriamine pentaacetic acid (DEPTA). Suitable organo aminophosphonic acid compounds include: ethylenediamine tetrakis (methylenephosphonic acid); 1-hydroxyethane 1,1-diphosphonic acid (HEDP); and aminotri (methylenephosphonic acid). In certain embodiments, the composition can include amino tri methylene phosphonic acid, which is available as Dequest™ 2000 from Monsanto. In other embodiments, the composition can include glutamic acid, N,N-diacetic acid, tetra sodium salt, which is available as Dissolvine™ GL from AkzoNobel.

In certain embodiments, the composition can include a C₁₃-C₁₅ Fatty Alcohol EO 20:1, which is a nonionic surfactant with an average of 20 ethoxylate groups. In certain embodiments, the amount is 0.05 to 0.5 weight %.

In certain embodiments, the composition can contain a silicone as a defoamer, such as Dow Corning™ 1430 defoamer. In certain embodiments, The amount is 0.05 to 0.8 weight %.

In certain embodiments, the composition can be an aqueous composition that contains the linear polyether and water. In other embodiments, the linear polyether can be added directly to the laundering method.

In certain embodiments, the method increases the amount of fragrance release by at least 5, at least 10, or at least 20% as compared to a fragrance release without the use of the linear polyether. Fragrance release can be measured by using a gas chromatograph head space analysis.

### SPECIFIC EMBODIMENTS

In the examples below, the amounts of material are based on the as supplied weight of the material.

| Material (weight %) | Comparative | Example 1 |
|---|---|---|
| Tetranyl ™ AHT5090 Esterquat from Kao | 12.5 | 12.5 |
| Lactic acid (80% active) | 0.0625 | 0.0625 |
| Dequest ™ 2000 amino trimethyl | 0.09 | 0.09 |
| phosphonic acid | | |
| Fragrance | 1.3 | 1.3 |
| Encapsulated fragrance | 0.32 | 0.32 |
| DP5270 linear polyether having a weight | 0 | 1 |
| average molecular weight less than | | |
| 2000 that is terminated with | | |
| —N—(—CH₂—CH(OH)—CH₂—Cl)₂ | | |
| Water | Q.S. to 100 | Q.S. to 100 |

### Preparation Method

Weigh required amount of distilled water in a beaker. Add amino trimethyl phosphonic acid, lactic acid, and calcium chloride to water and mix. Heat to 60° C. Stir the solution using an overhead stirrer at 250 RPM for 2 minutes. In a beaker, heat esterquat to 65° C. Add esterquat into solution while stirring at 400 RPM. Mix the solution for 10 minutes. Add SNF™ polymer into the solution and stir for 10 minutes. Check the temperature of the mixture. On cooling to room temperature, add fragrance drop wise.

### Fabric Treatment with Fabric Softener

Prepare an approximate 2 kg load containing cotton hand towels (40.6 by 61 cm) without ballast, per product to be tested (washing machine).
Weigh out detergent samples and fabric softener for each wash.
Washing machine(s) should be cleaned by conducting a wash cycle at 70° C.

| | |
|---|---|
| Washer Type | Front Loading |
| Wash Cycle | Custom - 40° C., “Fast” Centrifugation |
| Wash Time | 77 minutes |
| Water Level | 23 liters used for all wash and rinse |
| | cycles |
| Wash Temperature | 40° C. |
| Rinse Temperature | Room Temperature |
| Spin Speed | 1200 RPM |
| Laundry Load Size | 2 Kg |
| Drying | Line drying overnight |
| Detergent | Ariel ™ Professional detergent from |
| | Europe |
| Dosage | 80 g |
| Fabric Softener | 110 g |

Set wash controls for custom cycle with specified wash period. Add detergent and fabric softener to respective compartments in washing machine. Add swatches to washing machine.
Start wash cycle
Wash for specified amount of time
Remove wash load
Samples are washed once, three, and five times
The swatches that are line dried.

### Evaluation

Each cotton hand-towel is placed in a booth. Fragrance intensity in the booth is assessed where panelists iron towels. Fragrance intensity is measured by 12 trained panelists. The fragrance intensity in the booth (not the fabric) is evaluated at six different time points: After entering the booth but before ironing; Assessing fragrance intensity in the booth while ironing for 2 minutes, but rated fragrance intensity after 15 seconds, 60 seconds and 120 seconds of ironing; Keeping the iron on the side and after 15 seconds while remaining in the booth and rating fragrance intensity; and Walk out of the booth, close the door, rejuvenate nose and peep through window and rating fragrance intensity.

The average ratings from the panelists are given in the tables below. The rating scale is 0 for no fragrance intensity up to 10, for highest fragrance intensity.

| | | While, sec | | | | |
|---|---|---|---|---|---|---|
| Panelist | Before | 15 | 60 | 120 | After | Window |

Comparative One Wash

| | | | | | | |
|---|---|---|---|---|---|---|
| Average | 0.3 | 2.6 | 3.3 | 3.2 | 2.3 | 1.7 |
| StdDev | 0.6 | 1.5 | 1.1 | 1.5 | 1.4 | 1.7 |

Example 1 One Wash

| | | | | | | |
|---|---|---|---|---|---|---|
| Average | 0.4 | 3.0 | 3.5 | 3.5 | 2.9 | 2.1 |
| StdDev | 0.8 | 1.5 | 1.3 | 1.4 | 1.2 | 1.3 |

Comparative Three Washes

| | | | | | | |
|---|---|---|---|---|---|---|
| Average | 0.3 | 2.8 | 3.1 | 3.1 | 2.5 | 1.9 |
| StdDev | 0.5 | 1.5 | 1.6 | 1.6 | 1.5 | 1.1 |

Example 1 Three Washes

| | | | | | | |
|---|---|---|---|---|---|---|
| Average | 0.4 | 3.4 | 3.7 | 3.6 | 3.1 | 2.3 |
| StdDev | 0.5 | 1.4 | 1.3 | 1.2 | 1.5 | 1.2 |

Comparative Five Washes

| | | | | | | |
|---|---|---|---|---|---|---|
| Average | 0.3 | 3.1 | 3.4 | 3.3 | 2.4 | 1.8 |
| StdDev | 0.5 | 1.7 | 1.8 | 2.0 | 2.0 | 1.8 |

Example 1 Five Washes

| | | | | | | |
|---|---|---|---|---|---|---|
| Average | 0.6 | 3.8 | 4.3 | 4.4 | 3.8 | 2.9 |
| StdDev | 0.9 | 1.3 | 1.0 | 1.6 | 1.4 | 1.5 |

| Ranking (N = 12) | Comparative | | | Example 1 | | |
|---|---|---|---|---|---|---|
| Number of | One | Three | Five | One | Three | Five |
| panelists ranking as: | Wash | Washes | Washes | Wash | Washes | Washes |
| Most Blooming | 2 | 5 | 4 | 3 | 3 | 7 |
| Moderate Blooming | 5 | 4 | 2 | 3 | 4 | 5 |
| Least Blooming | 4 | 2 | 5 | 6 | 5 | 0 |

These results show the following. Comparative (containing fragrance alone) blooms during ironing to certain extent. Also, such blooming is not significantly different even when the towels are washed repeatedly five times with Comparative. Blooming from towels washed five times with Example 1, however, is higher and significantly different than the towels that are washed five times with Comparative.

The presence of the polyether helps to provide unexpected blooming of fragrance when the towels are washed multiple times (more than 3 times). While not wishing to be bound by theory, one possible hypothesis is that unlike fragrance, there may be build-up of polymer due to multiple washings and thus deposited polymer may help to provide increased blooming of fragrance. It is also possible that the polymer may have the characteristics to deposit fragrance at increased levels.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight. The amounts given are based on the active weight of the material.

What is claimed is:

1. A method for increasing blooming of fragrance during ironing a fabric comprising laundering the fabric with a composition comprising:
a) a linear polyether having a weight average molecular weight less than 5000 that is terminated with —N—(—CH₂—CH(OH)—CH₂—Cl)₂, and
b) fragrance,
and ironing the fabric.

2. The method of claim 1, wherein the molecular weight is less than 4000.

3. The method of claim 1, wherein the molecular weight is less than 2000.

4. The method of claim 1, wherein the fabric is laundered at least 3.

5. The method of claim 1, wherein the composition is an aqueous composition.

6. The method of claim 1, wherein the composition is added during a rinse cycle during laundering.

7. The method of claim 1, wherein the laundering comprises washing the fabric and rinsing the fabric.

8. The method of claim 1 further comprising drying the fabric.

9. The method of claim 8, wherein the drying is line drying.

10. The method of claim 8, wherein the drying is dryer drying.

11. The method of claim 1, wherein the composition further comprises a fabric softener.

12. The method of claim 1, wherein the composition further comprises a surfactant.

13. The method of claim 1, wherein the polyether is present in the composition in an amount of 0.05 to 0.4 % by weight of the composition.

14. The method of claim 1, wherein the fragrance is in free form.

15. The method of claim 1, wherein the fragrance is encapsulated.

16. The method of claim 1, wherein the method increases the amount of fragrance release by at least 5 as compared to a fragrance release without laundering with the linear polyether.

17. (canceled)

18. (canceled)
